(19) United States
(12) Patent Application Publication
(10) Pub. No.: US 2020/0153769 A1
(43) Pub. Date: May 14, 2020

(54) Communication Method and Apparatus

(71) Applicant: Dingtalk Holding (Cayman) Limited, Grand Cayman (KY)

(72) Inventor: Aisong Ren, Zhejiang (CN)

(21) Appl. No.: 16/746,637

(22) Filed: Jan. 17, 2020

Related U.S. Application Data
(63) Continuation of application No. PCT/CN2018/095106, filed on Jul. 10, 2018.

(30) Foreign Application Priority Data
Jul. 21, 2017 (CN) 201710602336.9

(51) Int. Cl. H04L 12/58; G06Q 10/10

(52) U.S. Cl. CPC H04L 51/046; G06Q 10/103; H04L 51/08; H04L 51/16

(57) ABSTRACT

Communication method and apparatus are provided. The method may include obtaining comment information for approval events; and sending a communication session message related to the comment information to an associated user of the approval event through a communication session with the associated user.

### CROSS REFERENCE TO RELATED PATENT APPLICATIONS

This application claims priority to and is a continuation of PCT Patent Application No. PCT/CN2018/095106 filed on 10 Jul. 2018, and is related to and claims priority to Chinese Application No. 201710602336.9, filed on 21 Jul. 2017 and entitled “Communication Method and Apparatus,” which are hereby incorporated by reference in their entirety.

### TECHNICAL FIELD

The present disclosure relates to the technical field of communications, and particularly to communication methods and apparatuses.

### BACKGROUND

In related technologies, mobile group work platforms have become widely used in work processes of various groups such as enterprises, educational institutions, government agencies, etc. Such platforms can not only improve the efficiency of communications between users and reduce communication costs, but can also effectively improve the efficiency of user event processing and the work efficiency.

For example, a mobile group work platform can provide an approval function, so that the user A can use the approval function to initiate an approval event to the user B, and the user B can approve the approval event through the mobile group work platform, thus greatly improving the efficiency of approval.

In a related interface of an approval event, any participant of the approval event may post comment information in the related interface if having any questions or opinions on the approval event. Other participants may browse the related interface to view the comment information and provide respective responses.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of this, the present disclosure provides communication method and apparatus.

To achieve the above objectives, the present disclosure provides the following technical solutions.

In implementations, a communication method is provided, which includes obtaining comment information for approval events; and sending a communication session message related to the comment information to an associated user of the approval event through a communication session with the associated user.

In implementations, a communication method is provided, which includes obtaining a communication session message from a communication session for presentation in a communication session interface corresponding to the communication session; and displaying source information of the communication session message in an associated display area of the communication session message when the communication session message is related to comment information of an approval event, the source information being related to the approval event.

In implementations, a communication method is provided, which includes displaying comment information for an approval event; and switching to a communication session interface with a commenting party corresponding to the comment information in response to detecting a triggering operation for the comment information.

In implementations, a communication apparatus is provided, which includes a first acquisition unit that obtains comment information for an approval event; and a first sending unit that sends a communication session message related to the comment information to an associated user of the approval event through a communication session with the associated user.

In implementations, a communication apparatus is provided, which includes a second acquisition unit that obtains a communication session message from a communication session for presentation in a communication session interface corresponding to the communication session; and a second display unit that displays source information of the communication session message in an associated display area of the communication session message when the communication session message is related to comment information of an approval event, the source information being related to the approval event.

In implementations, a communication apparatus is provided, which includes a fourth display unit that displays comment information for an approval event; and a switching unit that switches to a communication session interface with a commenting party corresponding to the comment information in response to detecting a triggering operation for the comment information.

As can be seen from the above technical solutions, the present disclosure allow an automatic synchronization of comment information for an approval event as communication session message(s) by enabling information synchronization between an approval event and a communication session, thus implementing seamless connection and transparent transmission between the approval event and the communication session. This enables users to achieve more efficient communication operations based on communication sessions, and helps to improve the efficiency of communications.

### BRIEF DESCRIPTION OF THE DRAWINGS

FIG. 1 is a schematic structural diagram of a communication system according to an exemplary embodiment.

FIG. 2 is a flowchart of a communication method according to an exemplary embodiment.

FIG. 3 is a flowchart of another communication method according to an exemplary embodiment.

FIG. 4 is a flowchart of still another communication method according to an exemplary embodiment.

FIG. 5 is a schematic diagram of an approval event processing interface of an approving party according to an exemplary embodiment.

FIGS. 6A-6B are schematic diagrams of a comment information input interface according to an exemplary embodiment.

FIG. 7 is a schematic diagram of another approval event processing interface of an approving according to an exemplary embodiment.

FIG. 8 is a schematic diagram of a communication session interface according to an exemplary embodiment.

FIG. 9A is a schematic diagram of another communication session interface according to an exemplary embodiment.

FIG. 9B is a schematic diagram of another communication session interface according to an exemplary embodiment.

FIG. 10 is a schematic diagram of still another communication session interface according to an exemplary embodiment.

FIG. 11 is a schematic diagram of a communication session interface of a receiving party according to an exemplary embodiment.

FIG. 12 is a schematic diagram of another communication session interface of a receiving party according to an exemplary embodiment.

FIG. 13 is a schematic diagram of an approval event management interface of an initiating party according to an exemplary embodiment.

FIG. 14 is a schematic diagram of still another communication session interface according to an exemplary embodiment.

FIG. 15 is a schematic structural diagram of an electronic device according to an exemplary embodiment.

FIG. 16 is a block diagram of a communication apparatus according to an exemplary embodiment.

FIG. 17 is a block diagram of another communication apparatus according to an exemplary embodiment.

FIG. 18 is a block diagram of still another communication apparatus according to an exemplary embodiment.

### DETAILED DESCRIPTION

Exemplary embodiments will be described in detail herein, and examples thereof are illustrated in the accompanying figures. When the accompanying figures are described hereinafter, the same numerals in different accompanying figures refer to the same or similar elements unless indicated otherwise. Implementations described in the following exemplary embodiments do not represent all the embodiments that are consistent with the present disclosure, but rather are merely examples of apparatuses and methods that are consistent with aspects of the present disclosure as detailed in the appended claims.

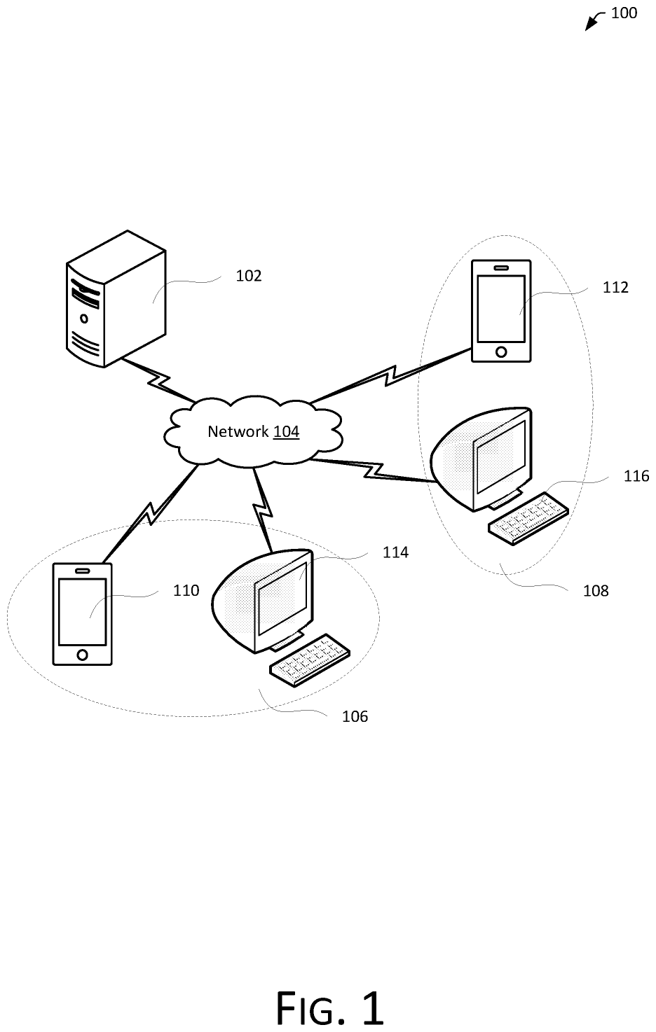

FIG. 1 is a schematic structural diagram of a communication system 100 according to an exemplary embodiment. As shown in FIG. 1, the system 100 may include a server 102, a network 104, and a plurality of electronic devices, such as an electronic device 106, an electronic device 108, etc.

The server 102 may be a physical server including a separate host. Alternatively, the server 102 may be a virtual server hosted by a host cluster. Alternatively, the server 102 may be a cloud server. During a process of operation, the server 102 can run a server-side program of a certain application to implement associated functions of the application. For example, when the server 102 runs a program of a mobile group work platform, a server end of the mobile group work platform can be implemented.

In the present embodiment, the mobile group work platform can not only realize communication functions, but can also be used as an integrated function platform for a number of other functions, for example, processing of internal events of groups such as approval events (e.g., day leaves, office item applications, financial and other approval events), attendance events, task events, log events, and processing of external events of the groups, such as ordering, purchasing, etc. The present disclosure has no limitations thereon.

More specifically, the mobile group work platform can be included in an instant messaging application in the related technologies, such as an enterprise instant messaging (EIM) application, e.g., Skype For Business®, Microsoft Teams®, Yammer®, Workplace®, Slack®, Enterprise WeChat®, Fixaoke®, Enterprise Fetion®, Enterprise Yixin®, etc. Apparently, an instant messaging function is only one of the communication functions supported by the mobile group work platform, and the mobile group work platform can implement functions more that those described above, which are not exhaustively described herein.

The electronic device 106 and the electronic device 108, etc., are electronic devices used by different users respectively to satisfy identities and roles of different users in communication processes. For example, when the user A is an initiating party of an approval event, the electronic device 106 can be used to initiate the approval event. When the user B is an approving party of the approval event, the approval event can be received and processed by the electronic device 108. The electronic device 106, the electronic device 108, and electronic devices used by other users may include a plurality of different types. For example, types of electronic devices may include a mobile phone, a personal computer (PC), a tablet device, and a notebook computer, a PDA (Personal Digital Assistant), a wearable device (such as smart glasses, a smart watch, etc.), etc. The present disclosure does not have any limitations thereon. During operation, the electronic device can run a client-side program of a certain application to implement associated service functions of the application. For example, when the electronic device runs a program of the mobile group work platform, a client end of the mobile group work platform can be implemented. It should be noted that application programs of the client end of the mobile group work platform can be pre-installed on the electronic device 106 and the electronic device 108, so that the client end can be started and run on the electronic device 106 and the electronic device 108. Apparently, when an online “client end” such as HTML5 technology is employed, the client end can be obtained and run without installing corresponding application programs on the electronic device 106 or the electronic device 108.

The network 104 through which the electronic device 106 and the electronic device 108 conduct interactions with the server 102 may include various types of wired or wireless networks. In implementations, the network 104 may include a Public Switched Telephone Network (PSTN) and the Internet. Furthermore, the electronic device 106 and the electronic device 108 can also conduct communications and interactions through the network 104, such as establishing a single-chat communication session between the electronic device 106 and the electronic device 108. Alternatively, a plurality of electronic devices can participate in a same group chat communication session, so that any user can send a communication message to all other users in the group chat communication session through his/her own electronic device.

The communication solutions of the present specification will be described in detail hereinafter with reference to the embodiments.

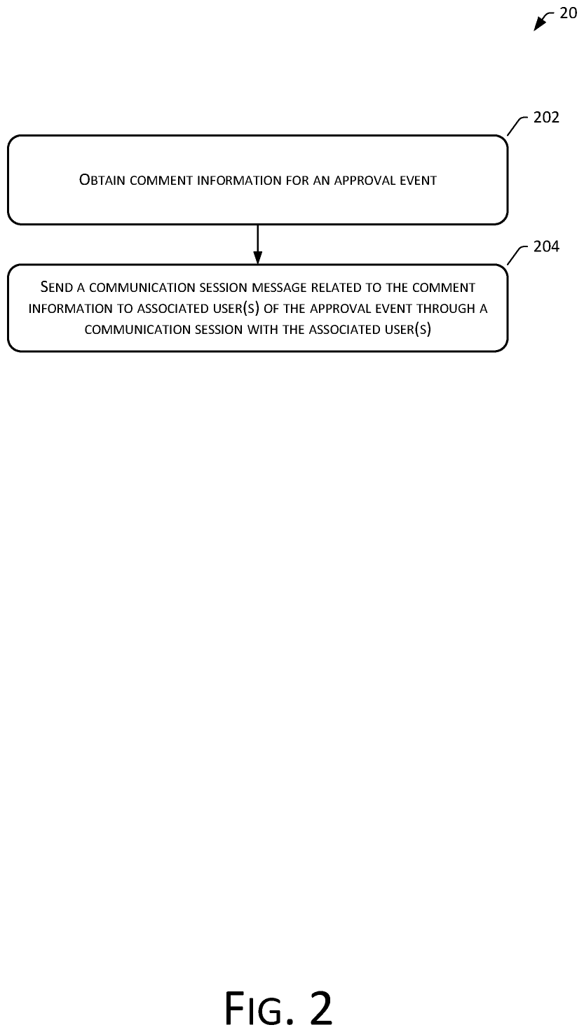

FIG. 2 is a flowchart of a communication method 200 according to an exemplary embodiment. As shown in FIG. 2, the method 200 may include the following operations.

Operation 202: Obtain comment information for an approval event.

Operation 204: Send a communication session message related to the comment information to associated user(s) of the approval event through a communication session with the associated user(s).

In implementations, the communication method of the embodiment that is shown in FIG. 2 can be applied in an electronic device, such as the electronic device 106, the electronic device 108, etc., as shown in FIG. 1. As such, any participant of the approval event can input comment information using a corresponding electronic device, and the electronic device can transmit a communication session message related to the comment information to associated user(s).

In implementations, the communication method of the embodiment that is shown in FIG. 2 can be applied in a server, such as the server 102 as shown in FIG. 1. The server 102 may receive comment information inputted by any participant of an approval event and send a communication session message related to the comment information to associated user(s).

In implementations, the embodiment shown in FIG. 2 can be included in a mobile group work platform. The mobile group work platform supports an approval function and a communication function. In this way, the user A can initiate an approval event to the user B through the mobile group work platform, to allow the user B to process the approval event through the mobile group work platform. Furthermore, the user B may send a communication session message related to comment information for the approval event to the user A through a communication session between the user A and the user B carried by the mobile group work platform, when the comment information is sent.

In implementations, the communication session may include a communication session between a sender of the comment information and the associated user(s). In other embodiments, the communication session may also include other communication sessions related to the associated user(s). For example, the mobile group work platform may maintain a virtual customer service, and the communication session may be established between the virtual customer service and the associated user(s).

The communication session refers to a session established between various communication parties. The session is used for implementing communication functions between the communication parties. For example, the sender of the comment information and the associated user(s) as described above belong to corresponding communication parties of the communication session. The session can be implemented based on any communication protocol in the related technologies, such as a UDP (User Datagram Protocol) protocol, a TCP (Transmission Control Protocol) protocol, or other types of communication protocols. The present disclosure does not have any limitations thereon.

In implementations, the associated user(s) may include at least one of: an initiating party of the approval event, and an approving party of the approval event. In other embodiments, other users associated with the approval event may also be included. For example, a supervisor of the approval event (e.g., supervising whether a processing period of the approval event fulfills requirements, etc.), a reviewing party (e.g., reviewing a processing result of the approval event, etc.), etc., can be treated as the associated user(s) here.

In implementations, sending prompt information for the communication session message may be displayed in a communication session interface corresponding to the communication session. As such, a sender of comment information may send a communication session message through the communication session interface by performing a user triggering operation on the sending prompt information upon confirming a desire of sending the communication session message. When a sender of comment information may avoid performing the above user triggering operation for the sending prompt information if he/she does not want to send a communication session message, thus preventing the communication session message from being sent through the communication session interface.

In implementations, when the communication session message is displayed in the communication session interface corresponding to the communication session, source information of the communication session message may be displayed in an associated display area of the communication session message. This can differentiate the communication session message from other communication session messages in the communication session interface on the one hand, and can help a user to quickly know an information source of the communication session message on the other hand, i.e., an association relationship between the communication session message and the approval event.

In implementations, in response to detecting a user triggering operation for the source information, a jump from the communication session interface to a related interface of the approval event may be performed, thereby implementing a quick jump between the communication session interface and the related interface of the approval event, and thus helping to improve the operating efficiency of the user.

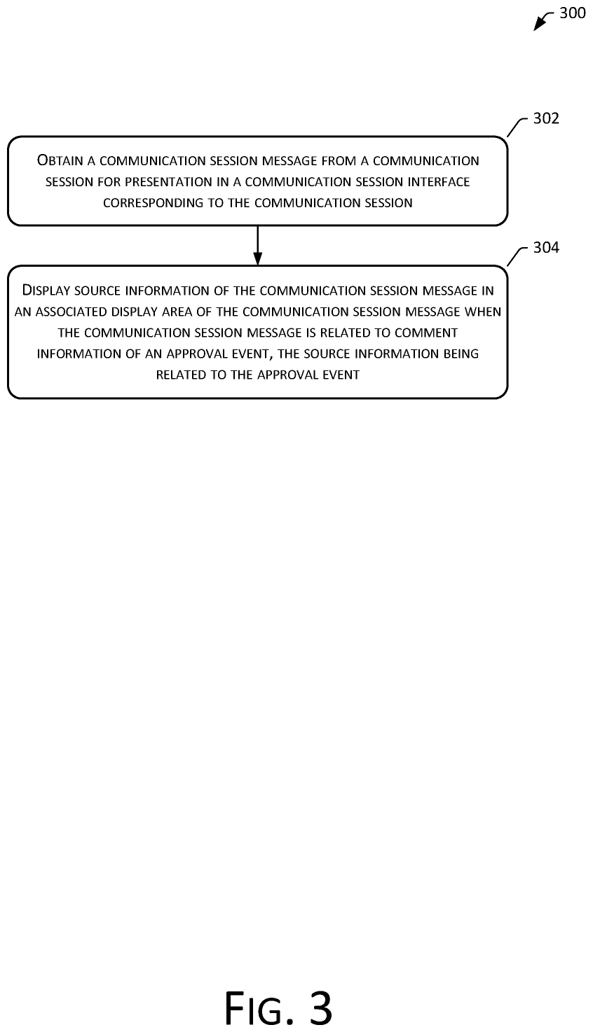

FIG. 3 is a flowchart of another communication method 300 according to an exemplary embodiment. As shown in FIG. 3, the method 300 may include the following operations.

Operation 302: Obtain a communication session message from a communication session for presentation in a communication session interface corresponding to the communication session.

Operation 304: Display source information of the communication session message in an associated display area of the communication session message when the communication session message is related to comment information of an approval event, the source information being related to the approval event.

In implementations, the embodiment shown in FIG. 3 can be included in a mobile group work platform. The mobile group work platform supports an approval function and a communication function. In this way, the user A can initiate an approval event to the user B through the mobile group work platform, to allow the user B to process the approval event through the mobile group work platform. Furthermore, the user B may send a communication session message related to comment information for the approval event to the user A through a communication session between the user A and the user B carried by the mobile group work platform, when the comment information is sent.

In implementations, displaying the source information of the communication session message in the associated display area of the communication session message can allow the communication session message to be distinguished from other communication session messages in the communication session interface on the one hand, and can help a user to quickly understand an information source of the communication session message on the other hand, i.e., a relationship between the communication session message and the approval event.

In implementations, in response to detecting a user triggering operation for the source information, a jump from the communication session interface to a related interface of the approval event may be performed, thereby implementing a quick jump between the communication session interface and the related interface of the approval event, and thus helping to improve the user's operating efficiency.

In implementations, the communication session message may include at least one of: a received message, or a sent message. When the communication session message is a received message, the embodiment shown in FIG. 3 is applied in a receiving device of the communication session message (i.e., an electronic device used by a receiving user). When the communication session message is a sent message, the embodiment shown in FIG. 3 is applied in a sending device of the communication session message (i.e., an electronic device used by a sending user).

In implementations, when the local user is an approving of the approval event, approval options for the approval event may be displayed in an associated display area of the communication session message. The approval options are used for implementing approval operations for the approval event, and helping the local user to quickly implement an approval operation for the approval event in a communication process, without switching to the related interface of the approval event, thus helping to simplify the approval operation and improve the approval efficiency.

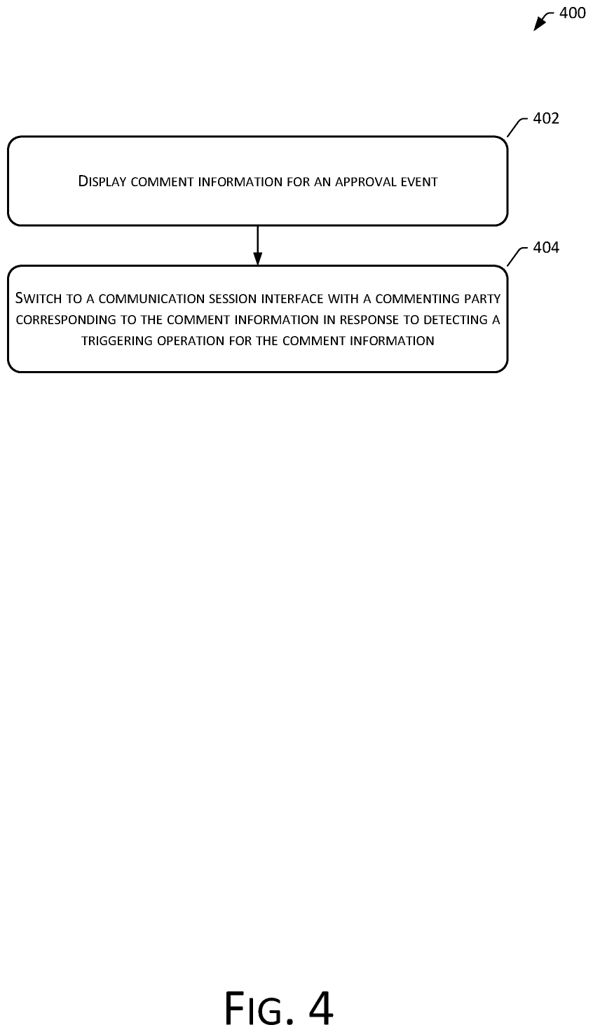

FIG. 4 is a flow chart of still another communication method 400 according to an exemplary embodiment. As shown in FIG. 4, the method 400 may include the following operations.

Operation 402: Display comment information for an approval event.

Operation 404: Switch to a communication session interface with a commenting party corresponding to the comment information in response to detecting a triggering operation for the comment information.

In implementations, the embodiment shown in FIG. 4 can be included in a mobile group work platform. The mobile group work platform supports an approval function and a communication function. In this way, the user A can initiate an approval event to the user B through the mobile group work platform, to allow the user B to process the approval event through the mobile group work platform. The user A and the user B can send comment information for the approval event. When the user A or the user B performs a triggering operation on a certain piece of comment information, switching to a communication session interface with a commenting party corresponding to the comment information can be quickly performed, thus facilitating communication with the commenting party.

In implementations, in response to detecting a triggering operation for the comment information, a jump from a related interface of the approval event to the communication session interface corresponding to the commenting party is performed, thereby implementing a quick jump between the related interface of the approval event and the communication session interface, and thus helping to improve the user's operating efficiency.

In implementations, sending prompt information for the comment information may be displayed in the communication session interface. As such, the local user may implement a user triggering operation on the sending prompt information, and send a communication session message related to the comment information through the communication session interface, to express the subject content of a subsequent communication to a peer communication party, thereby facilitating the efficiency of communications.

In order to facilitate understanding, the technical solutions of the present disclosure will be described using an enterprise instant messaging application as an example. A mobile phone 110 and a mobile phone 112 (as shown in FIG. 1) are assumed to have enterprise instant messaging client ends running therein, and the server 102 is assumed to have an enterprise Instant messaging server running therein. Alternatively, a computer 114 and a computer 116 (as shown in FIG. 1) may be assumed to have enterprise instant messaging client ends running therein. The enterprise instant messaging client ends on the mobile phone 110 and the mobile phone 112 are logged with registered accounts of different users respectively. For example, the mobile phone 110 is logged with a registered account of the user A, so that the mobile phone 110 is configured as the enterprise instant messaging client end 1 corresponding to the user A. The mobile phone 112 is logged with a registered account of the user B, so that the mobile phone 112 is configured as the enterprise instant messaging client end 2 corresponding to the user B.

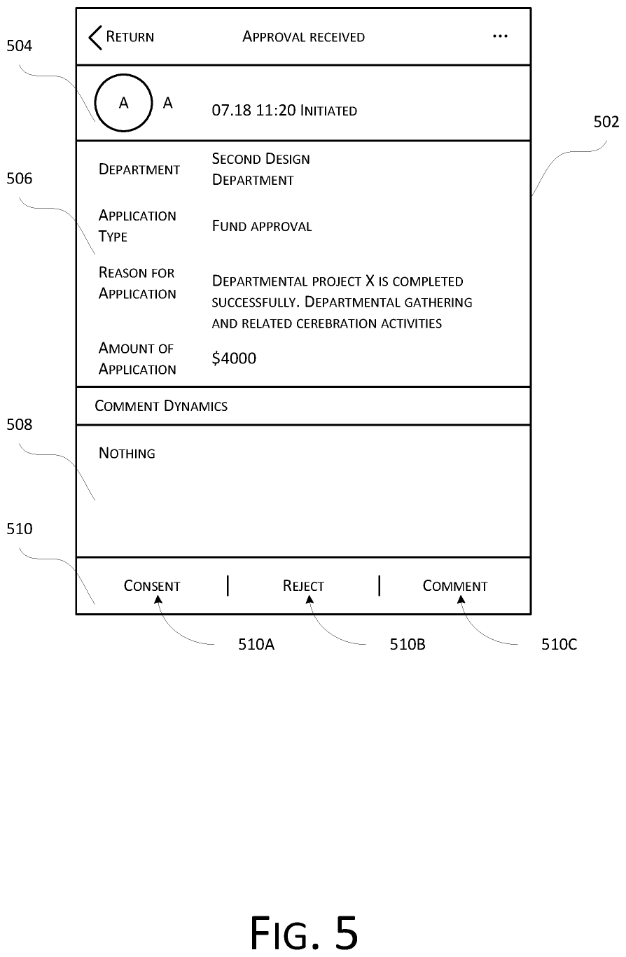

FIG. 5 is a schematic diagram of an approval event processing interface of an approving party according to an exemplary embodiment. The user A is assumed to create and initiate an approval event through the enterprise instant messaging client end 1, and the user B is an approving party of the approval event. The user B can view information about the approval event in an approval event processing interface 502 on the enterprise instant messaging client end 2 as shown in FIG. 5.

In implementations, the approval event processing interface 502 may include source information 504 as shown in FIG. 5, such as an initiating party as the user A, and an initiation time as “07.18 11:20”, etc.

In implementations, the approval event processing interface 502 may include approval content 506 as shown in FIG. 5. The approval content 506 may include one or more content items such as “department”, “application type”, “reason for application”, and “amount of applications”, etc., that are filled in by the user A who acts as the initiating party, to allow the user B (who acts as the approving party) for view, thereby determining a way of processing of the approval event.

In implementations, the approval event processing interface 502 may include comment dynamics 508 as shown in FIG. 5 for displaying comment information sent by participant(s) of the approval event. Since no comment information exists yet, “nothing” can be shown in FIG. 5.

In implementations, the approval event processing interface 502 may include processing options 510 as shown in FIG. 5. The processing options 510 can include a consent option 510A, a rejection option 510B, to allow the user B to confirm whether to approve or reject the approval event. The processing options 510 may include a comment option 510C to allow the user B to initiate a comment for the approval event.

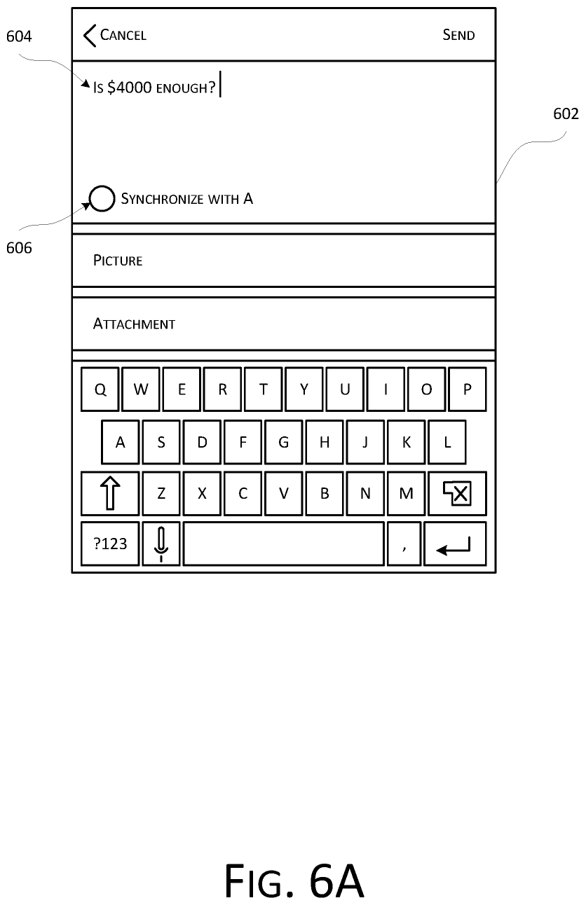

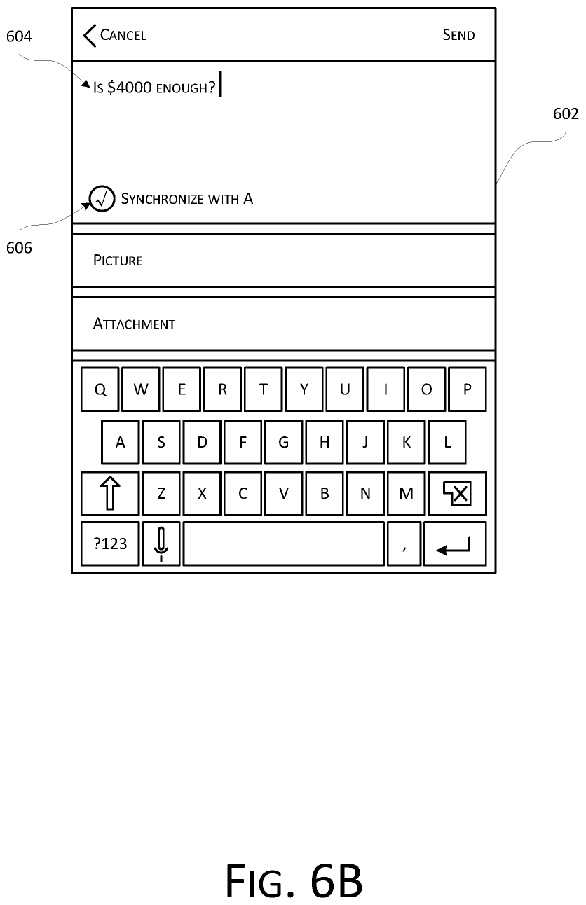

FIGS. 6A-6B are schematic diagrams of a comment information input interface according to an exemplary embodiment. In response to detecting a triggering operation of the user B for the comment option 510C, a transfer to a comment information input interface 602 as shown in FIGS. 6A-6B can be performed. As shown in FIGS. 6A-6B, the user B can input comment information 604 in the comment information input interface 602 through a manner of keyboard input. Apparently, in other embodiments, the user B may also adopt other input methods, such as voice input for automatically converting into a text or directly using voice, etc. In other embodiments, the comment information may include various forms. In addition to text or voice, “picture” or “attachment” (such as a document, etc.) as shown in FIGS. 6A-6B, etc., may be used. Alternatively, one or more of the various forms as described above may be used at the same time. The present disclosure does not have any limitations thereon.

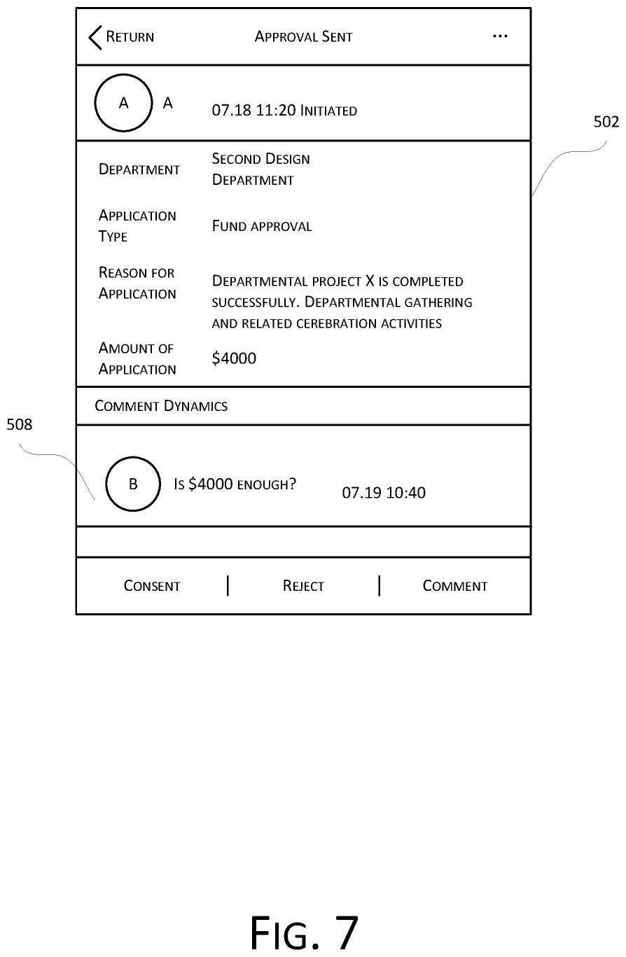

As shown in FIGS. 6A-6B, the comment information input interface 602 may include a synchronization option 606. In the embodiment as shown in FIG. 6A, when the user B triggers a “send” option without selecting the synchronization option 606, the comment information 604 can be sent, and displayed as the comment information in the comment dynamics 508 of an approval event processing interface 502 as shown in FIG. 7, to allow viewing by various participants of the approval event.

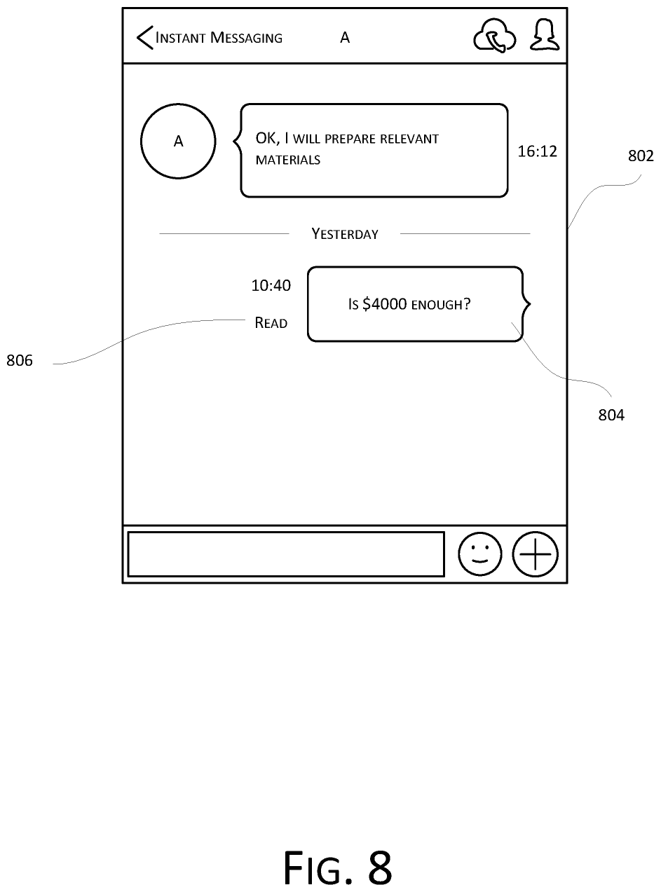

In the embodiment shown in FIG. 6B, when the user B triggers the “send” option with the synchronization option 606 being selected, in addition to being displayed as the comment information in the comment dynamic 508 of the approval event processing interface 502 shown in FIG. 7, the comment information 604 may also be processed as a communication session message 804 as shown in FIG. 8, and sent to a communication peer end through a communication session interface 802.

FIG. 8 is a schematic diagram of a communication session interface of an exemplary embodiment. In implementations, since the user B is the approving party of the approval event, the synchronization option 606 as described above is configured for the user A who acts as the initiating party. Therefore, the communication session interface 802 as shown in FIG. 8 corresponds to a communication session between the user B and the user A, such that the communication session message 804 can be sent to the user A through the communication session interface 802. Therefore, on the one hand, the user A and the user B can realize a more convenient and quick communication through the communication session interface 802. On the other hand, the communication content can be prevented from being viewed by other participants of the approval event, thus ensuring the security and privacy of information. In addition, in some embodiments, the communication session interface 802 may also display a reading status of the communication session message 804 by the user A who acts as the receiving party. For example, information of a reading status 806 as shown in FIG. 8 is “read”, thereby helping the user B to quickly determine if the user A has read the communication session message 804.

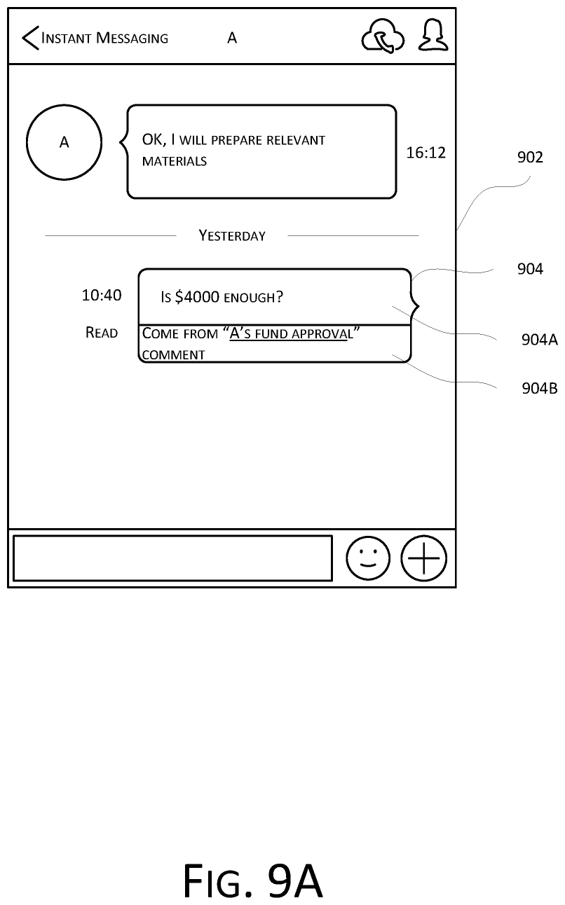

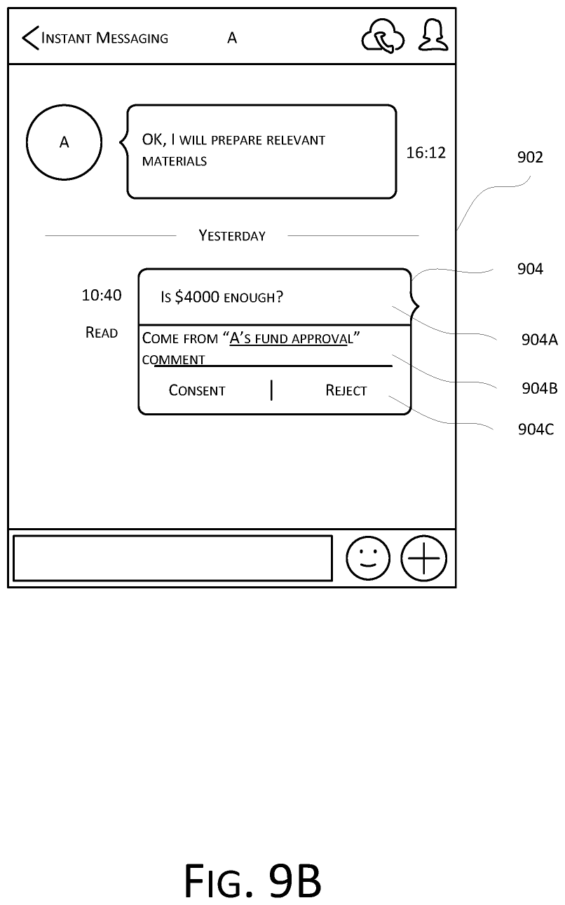

FIG. 9A is a schematic diagram of another communication session interface according to an exemplary embodiment. As shown in FIG. 9A, a communication session message 904A corresponding to the comment information 604 may be displayed in a session box 904 in a communication session interface 902. The session box 904 may further include source information 904B of the communication session message 904A. The source information 904B may remind the user B that the communication session message 904A is originated from a comment of “A's fund approval”, so that the user B can expand around the approval event during a process of subsequent communications with the user A, thus improving the efficiency of communications.

FIG. 9B is a schematic diagram of another communication session interface according to an exemplary embodiment. As shown in FIG. 9B, based on the embodiment shown in FIG. 9A, the session box 904 may further include a processing option 904C for the above-mentioned approval event, to enable the user B to communicate with the user A through the communication session interface 902, and quickly process the approval event, without switching to a corresponding approval event processing interface.

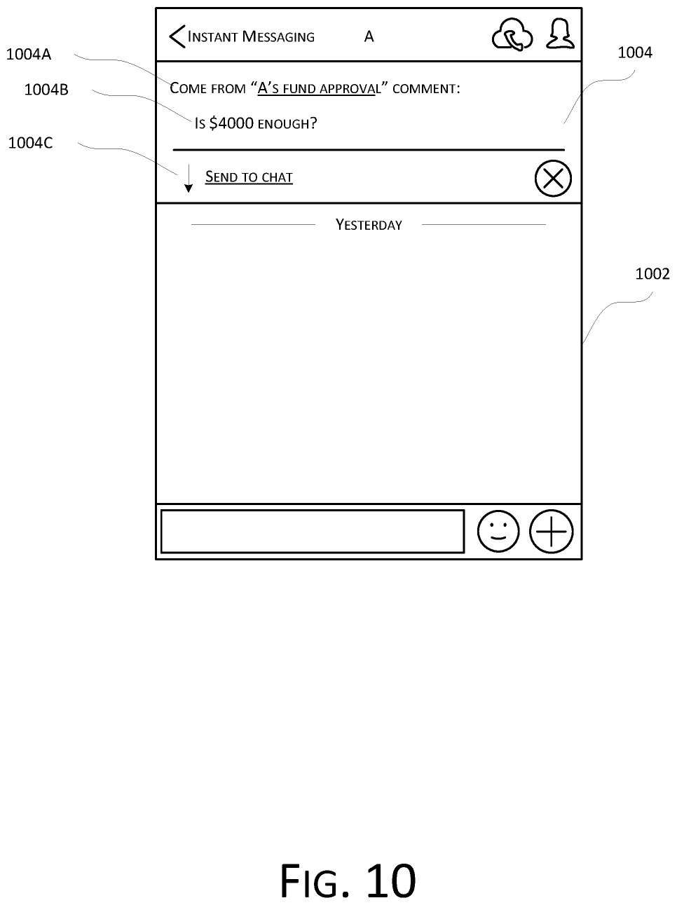

FIG. 10 is a schematic diagram of still another communication session interface according to an exemplary embodiment. As shown in FIG. 10, a communication session interface 1002 may display a prompt window 1004. The prompt window 1004 may include sending prompt information for the communication session message 804 or the communication session message 904A. For example, the sending prompt information may include source reminder information 1004A reminding that an information source of the communication session message 804 or the communication session message 904A is a comment of “A's fund approval”, comment content 1004B, and a send/trigger option 1004C. When the user B wants to implement a sending operation, the send/trigger option 1004C may be triggered, so that a communication session message related to the comment content 1004B can be sent based on the communication session interface 1002, and displayed as the communication session message 804 or communication session message 904A as described above, etc.

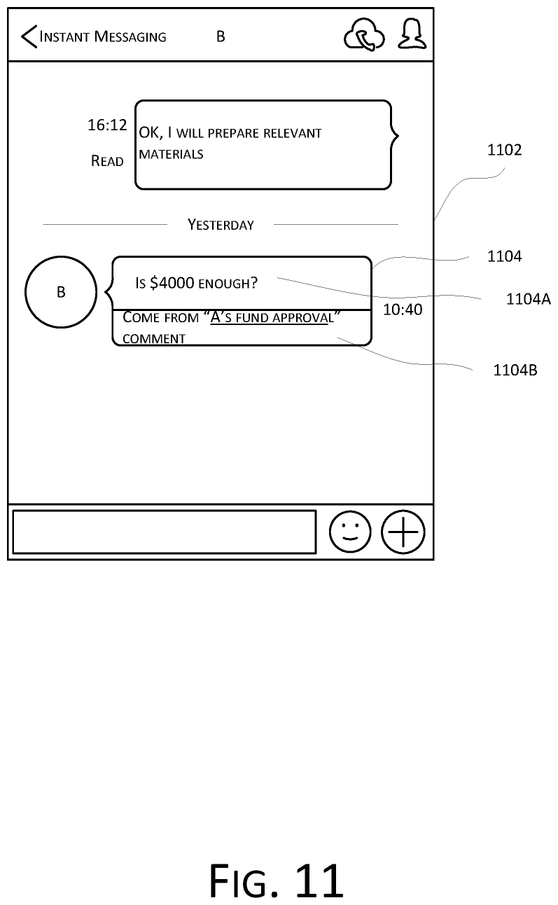

FIG. 11 is a schematic diagram of a communication session interface of a receiving party according to an exemplary embodiment. As shown in FIG. 11, the communication session message 804 or the communication session message 904A may be received by the user A from the user B, and displayed in the communication session interface 1102 as shown in FIG. 11. A displaying manner thereof can be referenced to the communication session message 804 or the communication session message 904A, etc. For example, in the embodiment shown in FIG. 11, a communication session message 1104A corresponding to the comment information 604 may be displayed in a session box 1104, as similar to the embodiment shown in FIG. 9A above. The session box 1104 may also include source information 1104B of the communication session message 1104A. The source information 1104B may remind the user A that the communication session message 1104A is originated from the comment of “A's fund approval”, so that the user A may expand around the approval event when communicating with the user B in a subsequent process, to improve the efficiency of communications.

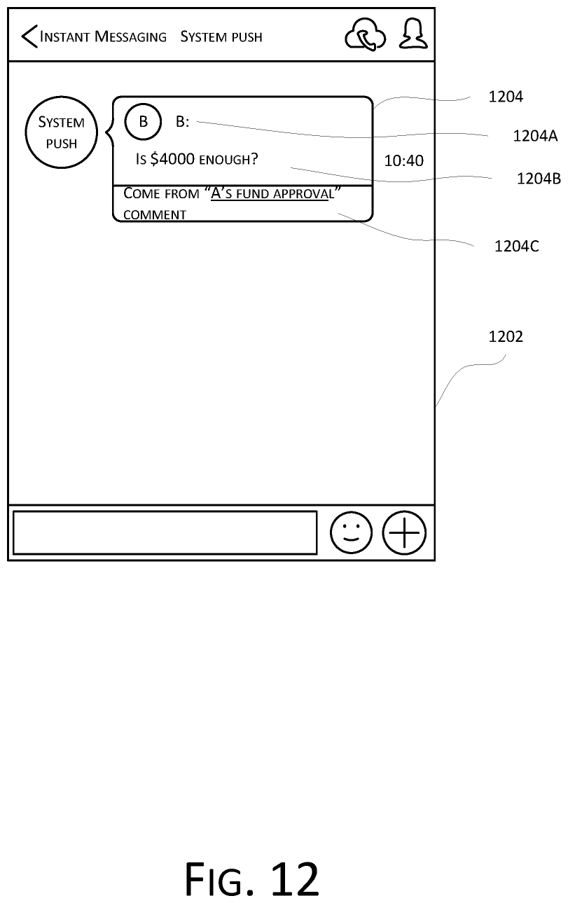

FIG. 12 is a schematic diagram of another communication session interface of a receiving party according to an exemplary embodiment. In the above embodiment, the communication session interface is a communication session between the user A and the user B. In some embodiments, a communication session message corresponding to the comment information 604 may also be sent through other communication sessions. For example, as shown in FIG. 12, a communication session interface 1202 may correspond to a communication session between the user A and a virtual service of “system push” maintained by the enterprise Instant messaging server. A corresponding communication session message may be separately sent through this “system push”, to reduce the probability that the user A misses the communication session message, and ensure that the user A can view, reply or perform other processing in time. In the communication session interface 1202, a communication session message 1204A corresponding to the comment information 604 may be displayed in a session box 1204, as similar to the embodiment shown in FIG. 9A above. The session box 1204 may also include source information 1204B of the communication session message 1204A. The source information 1204B (which include source information 1204C) may remind the user A that the communication session message 1204A is originated from a comment of “A's fund approval”. In other embodiments, the communication session message 1204A may also adopt other display forms, e.g., a form that is similar to the embodiment shown in FIG. 8. The present disclosure has no limitations thereon.

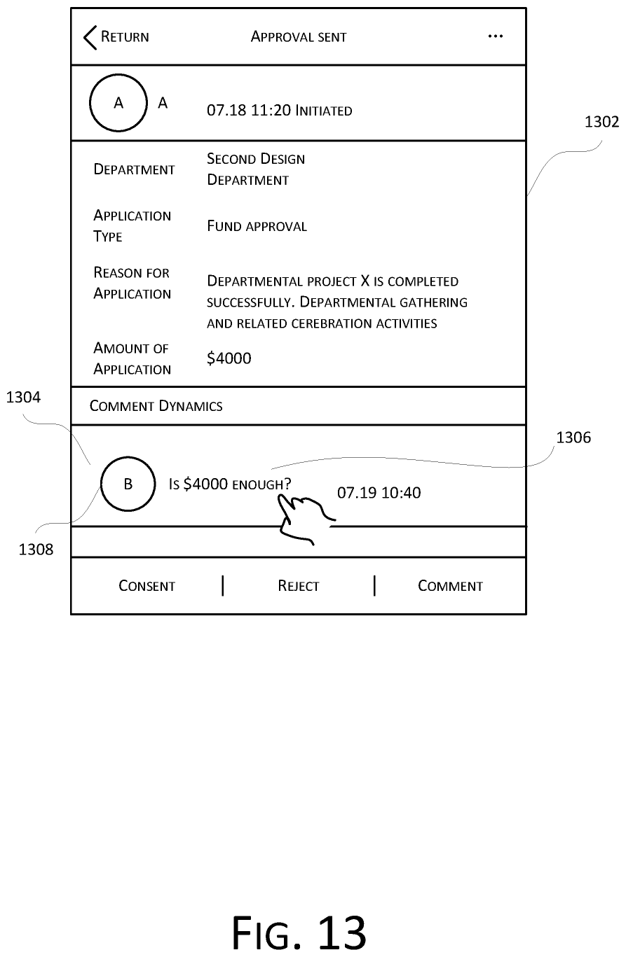

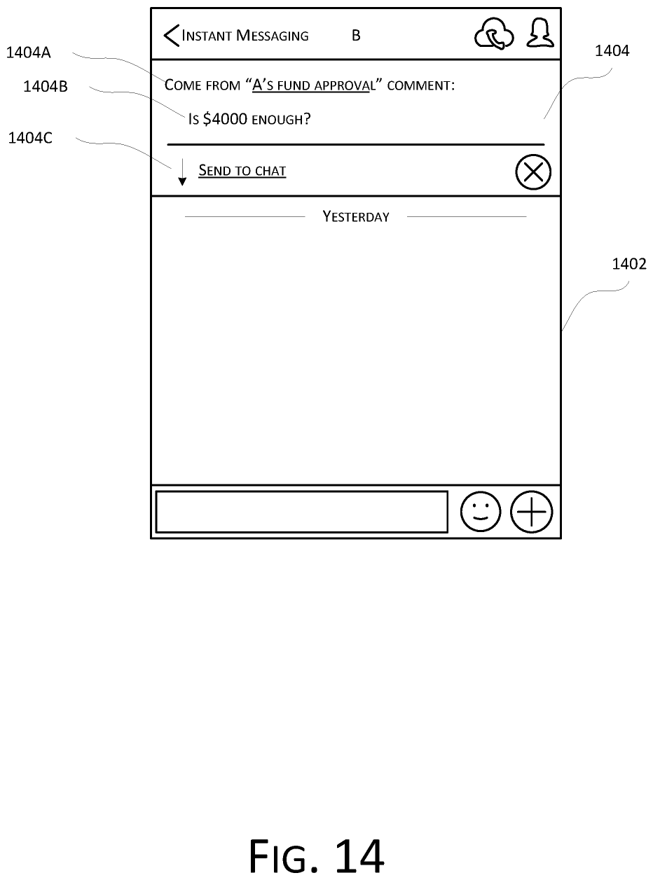

FIG. 13 is a schematic diagram of an approval event management interface of an initiating party according to an exemplary embodiment. As shown in FIG. 13, the user A who acts as an initiating party may view comment dynamics 1304 sent by each participant of an approval event in an approval event management interface 1302, such as comment information 1306 sent by the user B, etc. When the user A performs a user triggering operation on the comment information 1306, for example, the user A performs clicking, long pressing or double pressing on the comment information 1306, the enterprise instant messaging client end 1 may jump to the communication session interface 1402 as shown in FIG. 14. The communication session interface 1402 corresponds to a communication session between the user A and the user B (i.e., a sending user of the comment information 1306), thereby greatly simplifying the complexity of operations of the user A between the approval event management interface 1302 and the communication session interface 1402, and helping to improve the communication efficiency.

In the communication session interface 1402 as shown in FIG. 14, reference may be made to the embodiment shown in FIG. 8 or FIG. 9A, i.e., the communication session message related to the comment information 1306 is directly sent through the communication session interface 1402. Alternatively, similar to the embodiment shown in FIG. 10, a prompt window 1404 may be displayed in the communication session interface 1402. The prompt window 1404 may include sending prompt information. For example, the sending prompt information may include source reminding information 1404A to remind the user A that an information source of a communication session message to be sent is “A's fund approval”, comment content 1404B, and a send/trigger option 1404C. When the user A wants to implement a sending operation, the send/trigger option 1404C can be triggered, such that a communication session message associated with the comment content 1404B can be sent based on the communication session interface 1402.

As shown in FIG. 13, in the comment dynamics 1304 of the approval event management interface 1302, user information of a sending party corresponding to each piece of comment information may be displayed. For example, for the comment information 1306 sent by the user B, a profile photo 1308 of the user B may be shown, etc., to enable a quick jump to a contact information interface of the user B in response to detecting a user triggering operation on the profile photo 1308 is detected, thus facilitating the user A to view contact information of the user B.

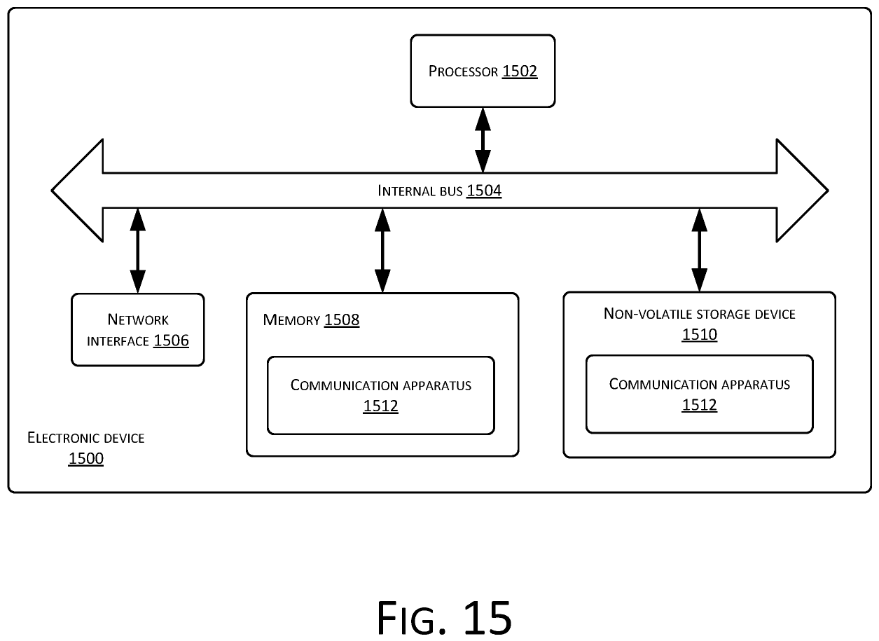

FIG. 15 is a schematic structural diagram of an electronic device 1502 according to an exemplary embodiment. Referring to FIG. 15, at a hardware level, the electronic device 1502 includes a processor 1506, an internal bus 1514, a network interface 1506, a memory 1508, and a non-volatile storage device 1510, and apparently may also include hardware needed by other services. The processor 1506 reads a corresponding computer program from the non-volatile storage device 1510 into the memory 1508, and then operates to form a communication apparatus 1512 at a logical level. Apparently, other than software implementations, the present disclosure does not exclude other manners of implementations, such as a logic device or a combination of software and hardware, etc. In other words, an execution body of the following flow of processing is not limited to various logical units, and may also be a hardware or logic device.

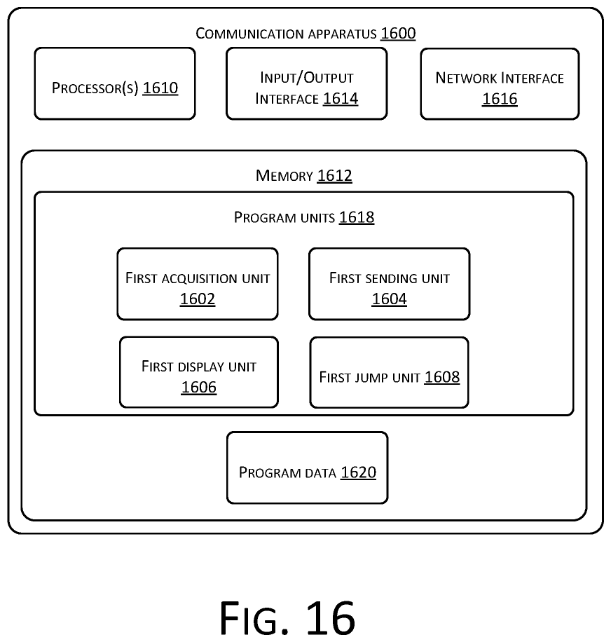

Referring to FIG. 16, in implementations, a communication apparatus 1600 may include a first acquisition unit 1602 that obtains comment information for an approval event; and a first sending unit 1604 that sends a communication session message related to the comment information to an associated user of the approval event through a communication session with the associated user.

In implementations, the communication session includes a communication session between a sending party of the comment information and the associated user.

In implementations, the associated user includes at least one of: an initiating party of the approval event, or an approving party of the approval event.

In implementations, the first sending unit 1604 is specifically configured to display sending prompt information for the communication session message in a communication session interface corresponding to the communication session; and send the communication session message through the communication session interface in response to detecting a user triggering operation for the sending prompt information.

In implementations, the apparatus 1602 also includes a first display unit 1606 that displays source information of the communication session message in an associated display area of the communication session message when the communication session message is displayed on a communication session interface corresponding to the communication session.

In implementations, the apparatus 1602 also includes a first jump unit 1608 that jumps from the communication session interface to a related interface of the approval event in response to detecting a user triggering operation for the source information.

In implementations, the apparatus 1602 may further include one or more processors 1610, a memory 1612, an input/output (I/O) interface 1614, and a network interface 1616.

The memory 1612 may include a form of computer readable media such as a volatile memory, a random access memory (RAM) and/or a non-volatile memory, for example, a read-only memory (ROM) or a flash RAM. The memory 1612 is an example of a computer readable media.

The computer readable media may include a volatile or non-volatile type, a removable or non-removable media, which may achieve storage of information using any method or technology. The information may include a machine-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1612 may include program units 1618 and program data 1620. The program units 1618 may include one or more units as described in the foregoing description and shown in FIG. 16.

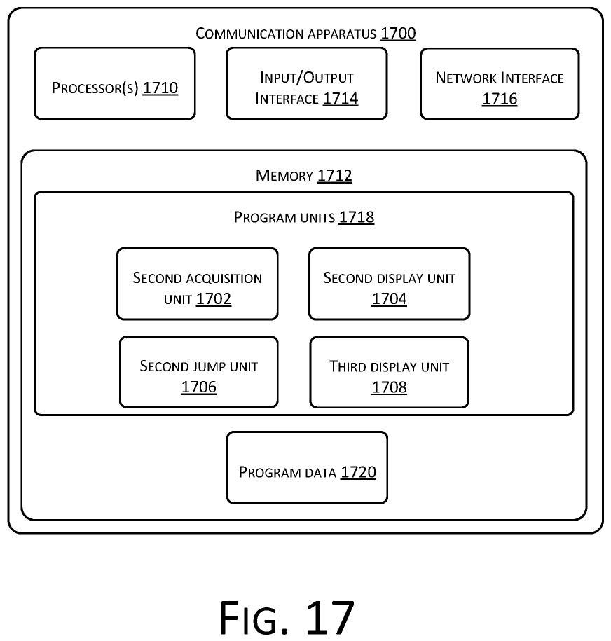

Referring to FIG. 17, in implementations, a communication apparatus 1700 may include a second acquisition unit 1702 that obtains a communication session message from a communication session for presentation in a communication session interface corresponding to the communication session; and a second display unit 1704 that displays source information of the communication session message in an associated display area of the communication session message when the communication session message is related to comment information of an approval event, the source information being related to the approval event.

In implementations, the apparatus 1700 also includes a second jump unit 1706 that jumps to a related interface of the approval event from the communication session interface in response to detecting a user triggering operation for the source information.

In implementations, the communication session message includes at least one of: a received message, or a sent message.

In implementations, the apparatus 1700 also includes a third display unit 1708 that displays an approval option for the approval event in an associated display area of the communication session message when a local user is an approving party of the approval event, the approval option being used for implementing an approval operation for the approval event.

In implementations, the apparatus 1700 may further include one or more processors 1710, a memory 1712, an input/output (I/O) interface 1714, and a network interface 1716. The memory 1712 may include a form of computer readable media as described in the foregoing description.

In implementations, the memory 1712 may include program units 1718 and program data 1720. The program units 1718 may include one or more units as described in the foregoing description and shown in FIG. 17.

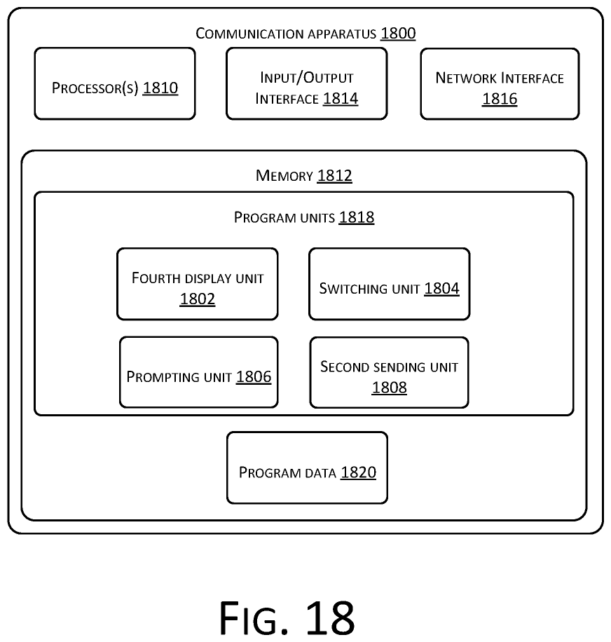

Referring to FIG. 18, in implementations, a communication apparatus 1800 may include:

a fourth display unit 1802 that displays comment information for an approval event; and

a switching unit 1804 that switches to a communication session interface with a commenting party corresponding to the comment information in response to detecting a triggering operation for the comment information.

In implementations, the apparatus 1802 also includes a prompting unit 1806 that displays sending prompt information for the comment information in the communication session interface; and a second sending unit 1808 that sends a communication session message related to the comment information through the communication session interface in response to detecting a user triggering operation for the sending prompt information.

In implementations, the apparatus 1802 may further include one or more processors 1810, a memory 1812, an input/output (I/O) interface 1814, and a network interface 1816. The memory 1812 may include a form of computer readable media as described in the foregoing description.

In implementations, the memory 1812 may include program units 1818 and program data 1820. The program units 1818 may include one or more units as described in the foregoing description and shown in FIG. 18.

The systems, apparatus, modules or units illustrated in the above embodiments may be implemented by a computer chip or an entity, or implemented by a product having certain functions. A typical device of implementation is a computer. A specific form of the computer may be a personal computer, a laptop computer, a cellular phone, a camera phone, a smart phone, a personal digital assistant, a media player, a navigation device, an email transceiver, a game control, a tablet computer, a wearable device, or any combination of a number of devices in these devices.

In a typical configuration, a computer includes one or more processors (CPUs), an input/output interface, a network interface, and memory.

The memory may include a form of computer readable media such as a volatile memory, a random access memory (RAM) and/or a non-volatile memory, for example, a read-only memory (ROM) or a flash RAM. The memory 516 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

It also needs to be noted that terms “including” or “containing” or any other variations are intended to encompass a non-exclusive inclusion, such that a process, method, article, or device including a series of elements not only includes these elements, but also includes other elements that are not explicitly listed, or includes elements that are inherent to such process, method, article, or device. Without any further limitation, an element defined by a phrase “including a . . . ” does not exclude the presence of additional equivalent elements in a process, method, article, or device including such element.

Specific embodiments of the present specification have been described above. Other embodiments fall within the scope of the appended claims. In some cases, actions or operations recited in the claims can be performed in an order different from the orders in the embodiments, and still achieve the desired results. In addition, processes depicted in the figures are not required to be in a particular order or in a sequential order as shown, in order to achieve the desired results. In some embodiments, multitasking and parallel processing are also possible or may be advantageous.

Terms used in the present disclosure are merely for the purpose of describing particular embodiments, and are not intended to limit the one or more embodiments. Singular forms “a”, “said”, and “the” are intended to include a plural form, unless other meanings are clearly express in the context. It should also be understood that a term “and/or” used herein refers to and encompasses any and all possible combinations of one or more of associated items that are listed.

It should be understood that, although terms “first”, “second”, and “third”, etc. may be used to describe various types of information in the present disclosure, these pieces of information should not be limited to these terms. These terms are only used for distinguishing the same type of information from each other. For example, first information may also be referred to as second information without departing from the scope of the one or more embodiments of the present disclosure. Similarly, the second information may also be referred to as the first information. Depending on the context, a term “if” used herein may be interpreted as “when” or “at the time when” or “in response to a determination”.

The above descriptions are only exemplary embodiments of the present disclosure, and are not intended to limit the present disclosure. Any modifications, equivalent replacements, improvements, etc., that are within the spirit and principles of the present disclosure, are intended to be included within the scope of the protection of the present disclosure.

The present disclosure can be further understood using the following clauses.

Clause 1: A communication method comprising: obtaining comment information for approval events; and sending a communication session message related to the comment information to an associated user of the approval event through a communication session with the associated user.

Clause 2: The method of Clause 1, wherein the communication session comprises a communication session between a sending party of the comment information and the associated user.

Clause 3: The method of Clause 1, wherein the associated user comprises at least one of: an initiating party of the approval event, or an approving party of the approval event.

Clause 4: The method of Clause 1, wherein sending the communication session message related to the comment information to the associated user of the approval event through the communication session with the associated user comprises: displaying sending prompt information for the communication session message in a communication session interface corresponding to the communication session; and sending the communication session message through the communication session interface in response to detecting a user triggering operation for the sending prompt information.

Clause 5: The method of Clause 1, further comprising displaying source information of the communication session message in an associated display area of the communication session message when the communication session message is displayed on a communication session interface corresponding to the communication session.

Clause 6: The method of Clause 5, further comprising jumping from the communication session interface to a related interface of the approval event in response to detecting a user triggering operation for the source information.

Clause 7: A communication method comprising: obtaining a communication session message from a communication session for presentation in a communication session interface corresponding to the communication session; and displaying source information of the communication session message in an associated display area of the communication session message when the communication session message is related to comment information of an approval event, the source information being related to the approval event.

Clause 8: The method of Clause 7, further comprising jumping to a related interface of the approval event from the communication session interface in response to detecting a user triggering operation for the source information.

Clause 9: The method of Clause 7, wherein the communication session message comprises at least one of: a received message, or a sent message.

Clause 10: The method of Clause 7, further comprising displaying an approval option for the approval event in an associated display area of the communication session message when a local user is an approving party of the approval event, the approval option being used for implementing an approval operation for the approval event.

Clause 11: A communication method comprising: displaying comment information for an approval event; and switching to a communication session interface with a commenting party corresponding to the comment information in response to detecting a triggering operation for the comment information.

Clause 12: The method of Clause 11, further comprising: displaying sending prompt information for the comment information in the communication session interface; and sending a communication session message related to the comment information through the communication session interface in response to detecting a user triggering operation for the sending prompt information.

Clause 13: A communication apparatus comprising: a first acquisition unit that obtains comment information for an approval event; and a first sending unit that sends a communication session message related to the comment information to an associated user of the approval event through a communication session with the associated user.

Clause 14: The apparatus of Clause 13, wherein the communication session comprises a communication session between a sending party of the comment information and the associated user.

Clause 15: The apparatus of Clause 13, wherein the associated user comprises at least one of: an initiating party of the approval event, or an approving party of the approval event.

Clause 16: The apparatus of Clause 13, wherein the first sending unit is specifically configured to: display sending prompt information for the communication session message in a communication session interface corresponding to the communication session; and send the communication session message through the communication session interface in response to detecting a user triggering operation for the sending prompt information.

Clause 17: The apparatus of Clause 13, further comprising a first display unit that displays source information of the communication session message in an associated display area of the communication session message when the communication session message is displayed on a communication session interface corresponding to the communication session.

Clause 18: The apparatus of Clause 17, further comprising a first jump unit that jumps from the communication session interface to a related interface of the approval event in response to detecting a user triggering operation for the source information.

Clause 19: A communication apparatus comprising: a second acquisition unit that obtains a communication session message from a communication session for presentation in a communication session interface corresponding to the communication session; and a second display unit that displays source information of the communication session message in an associated display area of the communication session message when the communication session message is related to comment information of an approval event, the source information being related to the approval event.

Clause 20: The apparatus of Clause 19, further comprising a second jump unit that jumps to a related interface of the approval event from the communication session interface in response to detecting a user triggering operation for the source information.

Clause 21: The apparatus of Clause 19, wherein the communication session message comprises at least one of: a received message, or a sent message.

Clause 22: The apparatus of Clause 19, further comprising a third display unit that displays an approval option for the approval event in an associated display area of the communication session message when a local user is an approving party of the approval event, the approval option being used for implementing an approval operation for the approval event.

Clause 23: A communication apparatus comprising: a fourth display unit that displays comment information for an approval event; and a switching unit that switches to a communication session interface with a commenting party corresponding to the comment information in response to detecting a triggering operation for the comment information.

Clause 24: The apparatus of Clause 23, further comprising: a prompting unit that displays sending prompt information for the comment information in the communication session interface; and a second sending unit that sends a communication session message related to the comment information through the communication session interface in response to detecting a user triggering operation for the sending prompt information.

What is claimed is:

1. A method implemented by one or more computing devices, the method comprising:
obtaining comment information for approval events; and
sending a communication session message related to the comment information to an associated user of the approval event through a communication session with the associated user.

2. The method of claim 1, wherein the communication session comprises a communication session between a sending party of the comment information and the associated user.

3. The method of claim 1, wherein the associated user comprises at least one of: an initiating party of the approval event, or an approving party of the approval event.

4. The method of claim 1, wherein sending the communication session message related to the comment information to the associated user of the approval event through the communication session with the associated user comprises displaying sending prompt information for the communication session message in a communication session interface corresponding to the communication session.

5. The method of claim 4, wherein sending the communication session message related to the comment information to the associated user of the approval event through the communication session with the associated user further comprises sending the communication session message through the communication session interface in response to detecting a user triggering operation for the sending prompt information.

6. The method of claim 1, further comprising displaying source information of the communication session message in an associated display area of the communication session message when the communication session message is displayed on a communication session interface corresponding to the communication session.

7. The method of claim 6, further comprising jumping from the communication session interface to a related interface of the approval event in response to detecting a user triggering operation for the source information.

8. One or more computer readable media storing executable instructions that, when executed by one or more processors, cause the one or more processors to perform acts comprising:
obtaining a communication session message from a communication session for presentation in a communication session interface corresponding to the communication session; and
displaying source information of the communication session message in an associated display area of the communication session message when the communication session message is related to comment information of an approval event, the source information being related to the approval event.

9. The one or more computer readable media of claim 8, the acts further comprising jumping to a related interface of the approval event from the communication session interface in response to detecting a user triggering operation for the source information.

10. The one or more computer readable media of claim 8, wherein the communication session message comprises at least one of: a received message, or a sent message.

11. The one or more computer readable media of claim 8, the acts further comprising displaying an approval option for the approval event in an associated display area of the communication session message when a local user is an approving party of the approval event, the approval option being used for implementing an approval operation for the approval event.

12. The one or more computer readable media of claim 8, wherein the user triggering operation comprises clicking, long pressing, or double pressing.

13. The one or more computer readable media of claim 11, wherein the approval option comprises at least one of: a consent option or a rejection option.

14. An apparatus comprising:
one or more processors;
memory;
a first acquisition unit stored in the memory and executable by the one or more processors to obtain comment information for an approval event; and
a first sending unit stored in the memory and executable by the one or more processors to send a communication session message related to the comment information to an associated user of the approval event through a communication session with the associated user.

15. The apparatus of claim 14, wherein the communication session comprises a communication session between a sending party of the comment information and the associated user.

16. The apparatus of claim 14, wherein the associated user comprises at least one of:
an initiating party of the approval event, or an approving party of the approval event.

17. The apparatus of claim 14, wherein the first sending unit is further configured to display sending prompt information for the communication session message in a communication session interface corresponding to the communication session.

18. The apparatus of claim 17, wherein the first sending unit is further configured to send the communication session message through the communication session interface in response to detecting a user triggering operation for the sending prompt information.

19. The apparatus of claim 14, further comprising a first display unit that displays source information of the communication session message in an associated display area of the communication session message when the communication session message is displayed on a communication session interface corresponding to the communication session.

20. The apparatus of claim 19, further comprising a first jump unit that jumps from the communication session interface to a related interface of the approval event in response to detecting a user triggering operation for the source information.
